(19) United States
(12) Patent Application Publication
(10) Pub. No.: US 2026/0276467 A1
(43) Pub. Date: Sep. 17, 2026

(54) RESETTABLE PRESSURE DIFFERENTIAL GAUGE WITH MEMORY

(71) Applicant: MIKROPOR MAKINA SANAYI VE TICARET ANONIM SIRKETI, Ankara (TR)

(72) Inventor: Ibrahim Kemal YAZICI, Ankara (TR)

(21) Appl. No.: 19/168,836

(22) PCT Filed: Feb. 6, 2024
(86) PCT No.: PCT/TR2024/050096

§ 371 Date: Sep. 25, 2025

(30) Foreign Application Priority Data
Apr. 27, 2023 (TR) 2023/004715

(51) Int. Cl. G01L 13/02; B01D 35/143; G01L 19/16

(52) U.S. Cl. CPC G01L 13/02; B01D 35/143; G01L 19/16

(57) ABSTRACT

The invention relates to a resettable pressure differential gauge device with memory, which enables to measure the pressure of the air during the filtration of compressed air in air systems, which can show the last pressure differential value reached by the gauge in case the filter blows up due to clogging during filtration, and which allows reuse thanks to its resettability.

### FIELD OF INVENTION

The invention relates to a resettable pressure differential gauge with memory that enables the indication of clogging conditions by measuring the inlet and outlet pressures of filters or equipment during the filtration of compressed air in air systems, and that can display the last pressure differential value reached in case of puncture, malfunction, damage or explosion of filters or equipment and allows reuse.

### STATE OF THE ART

In compressed air systems, there are filters or equipment on the line that provides filtration of compressed air. While these filters filter the compressed air, the particles in the air are kept inside the filter. These particles accumulate in the filter over time and cause clogging. The clogging creates a resistance to the compressed air passing through the filter and causes the compressed air to have difficulty passing through the filter. This clogging causes the lifespan of the filter to end and after a while the filter may lose its function and blow up. Therefore, gauges are installed in the filters or equipment to prevent blow-up by displaying the differential pressure and providing information on the state of clogging.

The principle of operation of the gauges in the present art is based on comparing the pressure of the air at the inlet of the filter or equipment with the pressure of the air at the outlet and displaying how much resistance the filter or equipment creates against the air. In this way, the gauges alert the user so that the filter/equipment can be replaced at the end of its life without the filter or equipment blowing up. However, due to reasons such as inadequate observation of the gauge, disruption of controls, etc., the alert of the gauge may not be noticed and the filter/equipment may fail to fulfill its duty by completing its life and may blow up.

One of the technical problems with pressure differential gauges in the art is that the filter/equipment cannot provide clear data on the pressure differential value at the blow-up position. Therefore, no inference can be made regarding the service life of the filter/equipment. Another technical problem with the devices in question is that the pressure difference value in the devices cannot be reset and therefore the device cannot be reused.

In the event that the filters/equipment expire or blow up occurs, the air resistance of the inlet air against the outlet air is eliminated due to the gap formed in the filter/equipment. Hence, the pressure difference value at the inlet and outlet of the filter/equipment is reset to zero and the pointer indicating the pressure difference does not remain in the blow up position. Therefore, as mentioned above, data on the maximum value reached by the pointer at the time of the blow up cannot be obtained and at the same time cannot be reused due to the non-resetting of the indicator.

There are improvements in the art with respect to devices that display the air pressure difference.

An example of the state of the art is the patent document JP6566339B1. The said document relates to a pressure difference gauge device for measuring the pressure difference in compressed air lines and giving an alarm in case of exceeding a specified pressure difference. The gauge subject to the document comprises a voltage input unit, a voltage output unit, a pressure difference detection unit for determining the pressure difference, a pointer and a dial.

Another example of the state of the art is the utility model document CN208847391U. The said document relates to a magnetic pressure differential gauge device. The pressure gauge device subject to the document comprises a dial, a pointer rotatably mounted on the dial, a junction box, an air inlet connected to said junction box. The junction box includes a slide, a slide bearing in which the slide slides, a spring located at one end of the slide and a magnet located at the other end of the slide and magnetically interacting with magnets connected to the junction box.

In cases such as the blow up of the filter/equipment with which the pressure gauge devices subject to the above-mentioned documents are used, it is thought that the gauge will not be able to clearly show the maximum differential pressure value reached by the gauge, the devices cannot be reset and therefore cannot be reused.

In order to eliminate the above-mentioned disadvantages, a memory and resettable pressure differential gauge device has been developed that enables the last pressure differential value to be displayed accurately and clearly in the event of puncture, malfunction, damage or explosion of filters or equipment during the filtration of compressed air in air systems, and to be reused thanks to its resettability.

### DETAILED DESCRIPTION OF THE INVENTION

The invention relates to a pressure difference gauge device for determining the pressure difference of filters or equipment for the filtration of compressed air in air systems.

One object of the invention is to use the pressure difference of filters and/or equipment used in compressed air filters to show the life-use status of the filters and/or equipment to the user, and thus to provide information to the user to intervene in the filter and/or equipment when necessary.

Another object of the invention is to accurately determine the last pressure difference value reached by the gauge device in case of puncturing, malfunctioning, damage or blow up of the filter and/or equipment in the pressure difference indicating devices of air filters and/or equipment. In this way, the user can have information about the service life of the filter and/or equipment.

Another object of the invention relates to the development of a pressure differential gauge device which is resettable and thus enabling reuse.

The invention is a resettable pressure difference gauge with memory, and in its most general form comprises;
at least one first air inlet duct (1) for inlet of compressed air into the device body before an inlet of an equipment positioned in a compressed air line, and at least one second air inlet duct (2) for inlet of compressed air from the equipment into the device body,
a pressure control cavity (4), divided into at least two sections by at least one cover (3), internal volume of the cover (3) configured to prevent the passage of air, for filling with compressed air from the first air inlet duct (1) on one side and with compressed air from the second air inlet duct (2) on other side, such that the cover (3) moves in the pressure control cavity (4) depending on pressure difference,
at least one pressure differential needle (5) located in the pressure control cavity (4) and connected to the cover (3), such that the pressure differential needle (5) moves with the cover (3) depending on the pressure difference,
a rack and pinion gear (7) comprising at least one needle cavity (6) such that the pressure differential needle (5) enters and advances into the needle cavity (6) due to an increase in the pressure difference, the rack and pinion gear (7) is triggered and then moves by the movement of the pressure differential needle (5) and the pressure differential needle (5) is removed from the rack and pinion gear (7) without moving the rack and pinion gear (7) due to a decrease in the pressure difference,
at least one pressure control spring (8) enclosing the pressure differential needle (5), such that the pressure control spring (8) allows the movement of the cover (3) and the pressure differential needle (5) to be transmitted to the rack and pinion gear (7) in a controlled manner, the pressure control spring (8) being compressed between the cover (3) and the rack and pinion gear (7) due to the increase in pressure difference and relaxed due to the decrease in pressure difference,
a pinion gear (9) in contact with the rack and pinion gear (7), the pinion gear (9) is triggered and then moves by the movement of the rack and pinion gear (7) and a pointer (10) configured to move in connection with said pinion gear (9),
a dial (11) on the body for indication of the life-use status of the equipment by means of the pointer (10),
a reset lock (12) in contact with the rack and pinion gear (7), the position of the rack and pinion gear (7) is changed by means of the pressure differential needle (5) due to the increase in the pressure difference, so that the position of the rack and pinion gear (7), the pinion gear (9) and the pointer (10) is returned to the initial position, and a reset key (13) for unblocking the reset lock (12).

In one embodiment of the invention, there is provided at least one shaft (14) for connecting the cover (3) and the pressure differential needle (5).

In one embodiment of the invention, there is provided at least one cover washer (15) for fixing the position of the pressure differential needle (5). Said embodiment of the invention preferably comprises at least one o-ring (16) and at least one felt (17) for securing the cover washer (15).

In one embodiment of the invention, there is provided at least one front spring washer (18) positioned between the spring (8) and the rack and pinion gear (7) for verifying the position of the spring (8). Said embodiment of the invention preferably comprises at least one rubber (19) positioned between the front spring washer (18) and the rack and pinion gear (7).

In one embodiment of the invention, there is provided on the device body at least one symbol (20) indicating the direction of flow for correct connection to the equipment to which the device is to be connected.

The invention provides that the equipment used in compressed air lines, by comparing the inlet and outlet pressure, the differential pressure of the equipment, i.e. the clogging of the equipment, is indicated with the help of a gauge, and in the event that this equipment explodes due to clogging, the last differential pressure level reached by this gauge is stored and displayed without any resetting, and that this gauge can be reset with the help of a switch to be reused later.

Views of the gauge device of one embodiment of the invention are shown in FIGS. 1 to 3. In the aforementioned figures, the device body, cover (3), cover washer (15), o-ring (16), felt (17), shaft (14), pressure differential needle (5), pressure differential control spring (8), front spring washer (18), rubber (19), rack and pinion gear (7) including needle cavity (6), pinion gear (9), pointer (10), dial (11), reset lock (12) and reset key (13) are shown. The o-ring (16) provides sealing to prevent any air leakage. The felt (17), cover washer (15), rubber (19) and front spring washer (18) also play a role in preventing air leakage by maintaining the position of the o-ring (16).

The resettable pressure differential gauge with memory is connected to the filter or compressed air equipment in the appropriate flow direction according to the flow direction symbol on the housing.

Before the equipment/filter inlet, the compressed air enters through the first air inlet duct (1) and fills the pressure control spring (8), while the air exiting after the equipment enters through the second air inlet duct (2) and fills the space opposite the pressure control spring (8). Over time, the pressure of the air exiting the equipment/filter decreases due to clogging. In this case, when a pressure difference starts to form between the inlet and outlet of the equipment/filter, in other words, when the pressure in the section where the pre-equipment compressed air entering from the first air inlet duct (1) starts to overcome the pressure in the section where the compressed air leaving the equipment entering from the second air inlet duct (2) is transmitted, the pressure control spring (8) starts to slowly compress in this direction. The spring (8), which slowly compresses due to the pressure difference, ensures that this movement is proportional. This pressure difference pushes the pressure differential needle (5) into the needle cavity (6) inside the rack and pinion gear (7) and the pressure differential needle (5) contacts and pushes the needle cavity (6) inside the rack and pinion gear (7) and advances the rack and pinion gear (7). With the movement of the rack and pinion gear (7), the pinion gear (9) rotates, and the pointer (10) rotates clockwise on the life-use status indicator.

As the air pressure permeability from the filter and/or equipment decreases, the user is informed about the clogging status and lifetime of the equipment/filter by the clockwise rotation of the pointer (10) and the point it shows on the life-use status dial (11). In cases where the lifetime of the equipment/filter decreases or the clogging condition increases, the pointer (10) moves towards the red zone on the dial (11) and the user is warned.

In the event of clogging/blow-up/damage/malfunction of the filter and/or equipment, etc., since there is no resistance between the pressurized inlet air and the pressurized outlet air, the pressure value is equalized and there is no pressure difference. Equalization of the pressure causes the compressed spring (8) to open/loosen. As a result of the equalization of the pressure difference, in addition to the opening of the pressure control spring (8), the pressure differential needle (5) comes out of the needle cavity (6) in the rack and pinion gear (7) without changing the position of the rack and pinion gear (7). Thus, the pinion gear (9) and pointer (10) do not move and the pointer (10) remains fixed in the position it was in before the equipment/filter blows up. In this way, the pointer (10) shows the user the last differential pressure before the blow-out on the life-use gauge.

If the filter and/or equipment fails, a new filter and/or equipment will be used. Thanks to the invention, it is not necessary to provide a new gauge for the new equipment/filter and the same gauge can be reset and reused. In order to reset and reuse the gauge, a reset key (13) is inserted into the reset lock (12) of the device and turned. After turning the reset key (13), the reset lock (12) is unblocked and the reset lock (12) comes into contact with the rack and pinion gear (7). By applying pressure on the reset lock (12) with the reset key (13), the rack and pinion gear (7) is pushed and the rack and pinion gear (7) is brought to the starting position. The rack and pinion gear (7), which reaches the starting position, turns the pinion gear (9) backwards and the pointer (10) reaches the first position. In this way, the life-cycle gauge is reset to zero. Once the life-cycle gauge is reset, it can be reused in a repaired or new filter or suitable compressed air equipment.

In brief, thanks to the invention, a pressure difference indicator device has been developed which informs the user about the lifetime and usage status of the equipment/filter with which it is used, where the last differential pressure can be observed by the user after the equipment/filter blows out, and which can be reused by being resettable.

### DESCRIPTION OF FIGURES

FIG. 1: Cross-sectional view of the resettable pressure differential gauge with memory

FIG. 2: Perspective view of the mechanism in the pressure control zone of the resettable pressure differential gauge with memory

FIG. 3: Perspective view of the mechanism in the pressure control zone of the resettable pressure differential gauge with memory from a different angle

FIG. 4: Perspective view of the resettable pressure differential gauge with memory

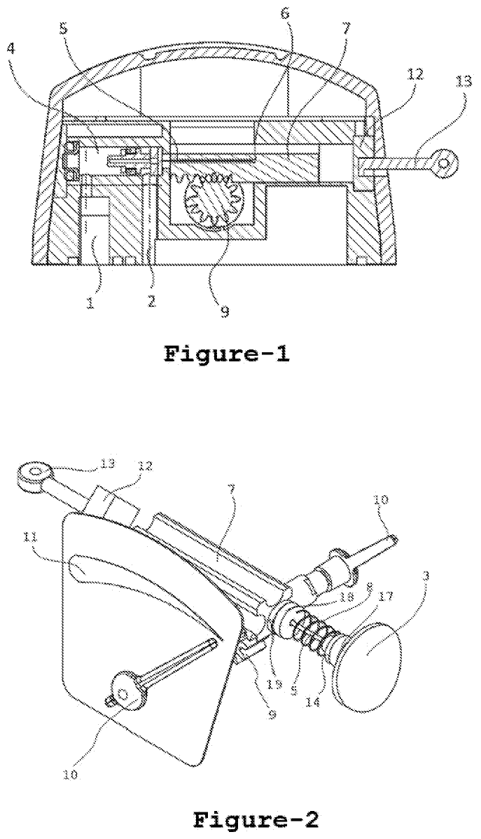

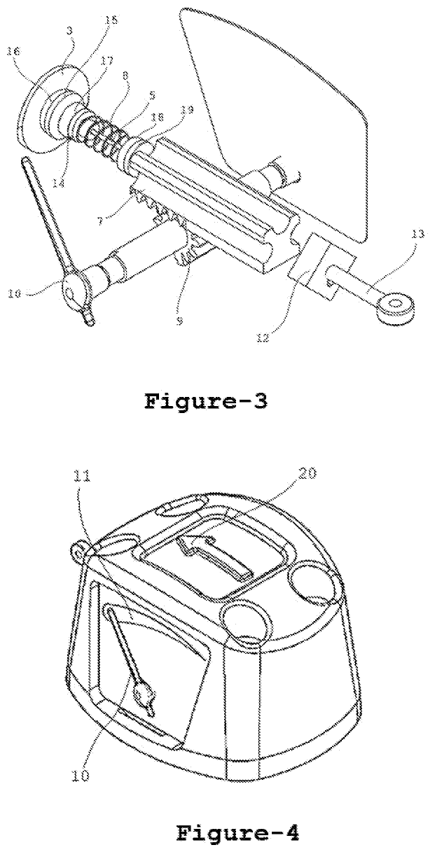

### EXPLANATIONS OF REFERENCE NUMBERS IN FIGURES

1. First air inlet duct
2. Second air inlet duct
3. Cover
4. Pressure control cavity
5. Pressure differential needle
6. Needle cavity
7. Rack and pinion gear
8. Spring
9. Pinion gear
10. Pointer
11. Dial
12. Reset lock
13. Reset key
14. Shaft
15. Cover washer
16. o-ring
17. Felt
18. Front spring washer
19. Rubber
20. Symbol

1. Pressure difference indicating device for compressed air systems, characterized in that it comprises;
at least one first air inlet duct (1) for inlet of compressed air into the device body before an inlet of an equipment positioned in a compressed air line, and at least one second air inlet duct (2) for inlet of compressed air from the equipment into the device body,
a pressure control cavity (4), divided into at least two sections by at least one cover (3), internal volume of the cover (3) configured to prevent the passage of air, for filling with compressed air from the first air inlet duct (1) on one side and with compressed air from the second air inlet duct (2) on other side, such that the cover (3) moves in the pressure control cavity (4) depending on pressure difference,
at least one pressure differential needle (5) located in the pressure control cavity (4) and connected to the cover (3), such that the pressure differential needle (5) moves with the cover (3) depending on the pressure difference,
a rack and pinion gear (7) comprising at least one needle cavity (6) such that the pressure differential needle (5) enters and advances into the needle cavity (6) due to an increase in the pressure difference, the rack and pinion gear (7) is triggered and then moves by the movement of the pressure differential needle (5) and the pressure differential needle (5) is removed from the rack and pinion gear (7) without moving the rack and pinion gear (7) due to a decrease in the pressure difference,
at least one pressure control spring (8) enclosing the pressure differential needle (5), such that the pressure control spring (8) allows the movement of the cover (3) and the pressure differential needle (5) to be transmitted to the rack and pinion gear (7) in a controlled manner, the pressure control spring (8) being compressed between the cover (3) and the rack and pinion gear (7) due to the increase in pressure difference and relaxed due to the decrease in pressure difference,
a pinion gear (9) in contact with the rack and pinion gear (7), the pinion gear (9) is triggered and then moves by the movement of the rack and pinion gear (7) and a pointer (10) configured to move in connection with said pinion gear (9),
a dial (11) on the body for indication of the life-use status of the equipment by means of the pointer (10),
a reset lock (12) in contact with the rack and pinion gear (7), the position of the rack and pinion gear (7) is changed by means of the pressure differential needle (5) due to the increase in the pressure difference, so that the position of the rack and pinion gear (7), the pinion gear (9) and the pointer (10) is returned to the initial position, and a reset key (13) for unblocking the reset lock (12).

2. A device according to claim 1, wherein it comprises at least one shaft (14) for connecting the cover (3) and the pressure differential needle (5).

3. A device according to claim 1, wherein it comprises at least one cover washer (15) for fixing the position of the pressure differential needle (5).

4. A device according to claim 3, wherein it comprises at least one o-ring (16) and at least one felt (17) for securing the cover washer (15).

5. A device according to claim 1, wherein it comprises at least one front spring washer (18) positioned between the spring (8) and the rack and pinion gear (7) for verifying the position of the spring (8).

6. An apparatus according to claim 5, wherein it comprises at least one rubber (19) positioned between the front spring washer (18) and the rack and pinion gear (7).
